(19) United States
(12) Patent Application Publication
(10) Pub. No.: US 2002/0083079 A1
(43) Pub. Date: Jun. 27, 2002

(54) System and method of managing documents

(75) Inventors: Steven E. Meier, Dallas, TX (US); Kevin B. Carr, Dallas, TX (US); Leyth M. Kedidi, Dallas, TX (US)

Correspondence Address: LOCKE LIDDELL & SAPP LLP, 600 TRAVIS, 3400 CHASE TOWER, HOUSTON, TX, 77002-3095, US

(73) Assignee: Interlegis, Inc.

(21) Appl. No.: 09/993,915

(22) Filed: Nov. 16, 2001

Related U.S. Application Data
(60) Provisional application No. 60/249,142, filed on Nov. 16, 2000.

(51) Int. Cl. G06F 7/00

(52) U.S. Cl. 707/104.1

(57) ABSTRACT

A system and method of managing documents wherein after document preparation, documents may be scanned to form a digital document image. After optical character recognition, a compressed digital image file with a text layer is created so that a separate text file may be extracted from the document image and tethered together by a unique identifier. The compressed digital image file and its corresponding extracted text file may be sent to a server and where an inventory of each word of every document is created. The images and text inventory are then inserted into a database such that users manipulating the system may use Boolean searches and/or activate hyperlinks tethered to document images for the purposes of navigation or the creation of index entries that may contain additional information about the documents. In the preferred method, the system allows the management of a plurality of documents over a wide area network such as the Internet.

### SPECIFICATION

This application relies upon U.S. Provisional Patent Application Serial No. 60/249,142 filed Nov. 16, 2000.

### FIELD OF THE INVENTION

This invention relates to systems and methods of managing documents, including without limitation paper or electronic documents, over a wide area network such as the Internet. In a preferred embodiment, this invention relates to managing documents produced by parties to litigation as well as documents generated during the pendency of such litigation.

### BACKGROUND OF THE INVENTION

Official judiciary statistics show that there are, on average, more than 15 million new civil lawsuits filed each year in the United States. Given the prodigious number of lawsuits, litigation represents an enormous financial drain on American business. In addition to diverting personnel and other resources from the commercial activities of the litigants, the actual costs associated with prosecuting or defending a lawsuit—even a comparatively minor one—can be staggering. More than half the costs of litigation are incurred during the so-called “discovery” phase—before a case actually comes to trial—where evidence is collected by the parties. Current discovery methods, document discovery in particular, are heavily paper-based, highly inefficient, and very expensive. Therefore, a need exists to provide an innovative, efficient, and highly cost-effective approach to managing information.

Apart from the sheer number of lawsuits, any litigation attorney will readily confirm that probably the single most overwhelming challenge faced is effectively and efficiently dealing with the huge volume of documents generated during the course of a lawsuit, particularly the mountains of paper produced by the parties thereto. From creating, handling and storing countless photocopies, to analyzing and reviewing documents, to locating and keeping track of the few important documents among every thousand produced, there are enormous problems. True efficiencies have been so elusive that it is a wonder that the legal system continues to function with anything resembling efficiency. Current document-management methods are so inefficient and costly that they actually play a major role in the decision of many litigants—even those with valid claims—to settle a case rather than litigate it through to a final resolution.

Discovery. Litigation is exceedingly costly for American business, both in terms of personnel and financial resources. In addition to distracting companies from their primary business activities, the cost to prosecute or defend even the most minor of lawsuits is significant. Just over half of the total cost of litigation accrues during the discovery phase of litigation, where the two main activities are: (1) document discovery—where the parties produce and exchange documentary evidence; and (2) depositions—where witness testimony is taken. Both activities are very important and, under current practice, heavily paper-based, inefficient, and costly.

Discovery presents perhaps the greatest logistical and financial problem in almost every lawsuit. Where tens of millions of documents are produced in complex matters and even comparatively modest cases easily generate tens of thousands of documents, the efficient and effective handling of information presents daunting challenges. Document-management methods have failed to keep up with the increasing volume of litigation, and true efficiencies have been elusive.

The failures of the prior art can be demonstrated by a representative “typical” large litigation matter, such as a multi-party case with two plaintiffs and six defendants. During the early stages of the proceedings, each of the eight parties will be subject to a request to produce documents that will require it to hand over to opposing parties its records and files relating to the matters in dispute; these records and files often consist of hundreds of thousands of pages of documents. The rules governing civil procedure tend to encourage, albeit unintentionally, the production of documents that are, as regards the largest portion of them, not directly relevant to any of the issues of the case.

For example, Rule 45 of the Federal Rules of Civil Procedure in the United States of America currently provides that a party must either produce its documents “as they are kept in the usual course of business” or “organize and label them to correspond with the categories in the document request.” In practice, few attorneys will bother to “organize and label” documents to respond to specific requests. Not only is it time-consuming for the attorney and expensive for the client, but it also does the work of opposing counsel by readily and clearly identifying documents that are likely harmful to the producing party's own case.

Rather, parties find that there are certain tactical advantages in producing documents “as they are kept in the usual course of business”, not the least of which is that the producing party may flood opposing counsel with hundreds of thousands of documents, most of which are irrelevant to the issues being litigated (a so-called “document dump”). Locating relevant or important documents becomes akin to finding the proverbial “needle in a haystack”.

As discovery proceeds into its next stages, depositions will be taken of parties and witnesses, resulting in even more information being generated, including dozens of deposition transcripts and hundreds of deposition exhibits. Moreover, there will be a flurry of new documents generated, such as correspondence, memoranda, motions, pleadings and the like. Keeping track of all this information becomes increasingly taxing as the case progresses.

Document Production. In order better to understand the innovative, useful, and non-obvious character of at least part of the company's service, it will be helpful to provide a brief description of document production. This description is not intended to be an entirely comprehensive discussion of all aspects of the process, but rather to provide a general overview of what is typical in litigation proceedings.

Assume in the above-referenced multi-party case that each of the eight litigants produces an average of 200,000 pages of documents (a modest number of documents for cases of this scale). The law firm representing each party will employ a small army of attorneys and junior staff to conduct a first review of all of the documents that are produced, not only by its own client, but also by each of the seven other parties. During this first review, an initial assessment of relevance is made; a portion of the produced documents is immediately determined to be irrelevant and a larger portion is “tagged” for possible later use. For a number of reasons, including that it occurs in the early stages of a case before the issues have crystallized, the first review tends to be very broad and inclusive. Consequently, the volume of tagged documents is very often not significantly less than the total number of documents produced. Assuming conservatively that an average of 75% of the produced documents are tagged, the “universe of documents” for the case (i.e. all documents designated as potentially relevant by all parties in the lawsuit) will total more than 1.2 million pages. There follow the four primary component activities in document production: copying, storage, coding and transport.

Copying. In conjunction with the first review, counsel for each party will arrange for photocopying the 1.2 million tagged documents. They will usually require two sets of copies: one so-called “working set” (i.e. the documents that are accessed and reviewed on a regular basis) and one so-called “pristine set” (i.e. the ultimate fall-back source for all tagged documents). As the case progresses, numerous additional copies will be made for various purposes (e.g., witness files; issues files; deposition preparation). A witness file, for example, may be used to prepare for a person's deposition or trial testimony and usually contains all documents authored by or addressed to that person, documents in which his or her name is mentioned, documents related that person's field of expertise, and the like. It is not uncommon for a witness file, particularly if the person is considered to be a “key witness”, to contain thousands of pages.

As a rule of thumb, there are on average 2.5 photocopies made for every page produced in a case. Thus, in the final analysis, each party in our representative example will have some 3 million pages of copies, and the eight parties will collectively have more than 24 million pages of copies. Given that less than 1% of all documents produced in a case are likely to be relevant to the issues of the case, and thus used by trial counsel, the inefficiency and waste are readily apparent. Storage. In larger firms, where several cases of such size may be pending at any given time, the volume of documents and the costs associated therewith are dramatic. The 3 million photocopies per party assumed in our representative example may require more than 1,000 standard-sized storage boxes or some 200 four-drawer filing cabinets. Each law firm is faced with the task of finding space to keep these documents (e.g., offices; storage or filing areas; dedicated “war rooms”) for the duration of the lawsuit. Even though most of the documents may never again see the light of day, they must remain readily accessible so long as the case remains active.

Statistics show that about 20% of all civil cases last two years, and about 50% of those last three years or longer. If the case lasts several years, productive and valuable office space is lost to document storage. Where a firm has several such cases pending at the same time, the loss is compounded. Research has shown that every large law firm uses the equivalent of at least one entire floor of its office space to store documents in active cases and that it spends hundreds of thousands of dollars annually for office space to store these documents. Additionally, there are several other expenses involved (e.g., logistical considerations; equipment costs for additional copies made in-house; personnel costs) that render the traditional system inefficient and costly.

Coding. After the initial review and photocopying, the tagged documents typically undergo a second and more detailed review called “coding”, the primary purpose of which is to provide a means to allow counsel to determine which of the 1.2 million pages comprising the universe of documents are relevant to their case. During the coding process, documents are individually examined, analyzed, summarized, and indexed. If documents are improperly or inadequately coded, the chances are greater that a key document will go undiscovered by trial counsel.

Each party typically does its own coding, with the information derived from the process usually becoming part of a database. Information in the database is often used to create a document index. For trial counsel, the index is the primary source of information regarding the documents that have been produced in the case. Meaningful access to the documents themselves depends primarily on the accuracy of the index. With traditional coding it is easy for a document to be inadequately or erroneously coded or misinterpreted by personnel (typically lower-level employees or third-party contractors who may not understand the issues of the case). Errors in coding lead to errors in the document index, which in turn enhances the likelihood that documents will be rendered “invisible” when a search for a particular document is later undertaken.

The same is true as regards transposition errors (e.g., document identification numbers [so-called “Bates numbers”] or dates) and spelling mistakes (e.g., names). Aside from the significant potential for error, the other main problems with coding are that: (1) it requires that all documents be coded in order to allow trial counsel to determine which ones are potentially relevant; and (2) it can take many months and cost hundreds of thousands of dollars to do so.

Coding the 1.2 million pages of tagged documents in our example may cost between $750,000 (assuming an “objective” limited-field coding—e.g., title, date, author, recipient, document type) and several million dollars (assuming a much more comprehensive exercise). Given that, on average, less than 1% of all coded documents are ever deemed relevant for use at trial, traditional document coding represents a significant waste of time and money. And yet, despite the amount of money spent on the coding process, significant problems still occur with great frequency. In one recent case a law firm billed its client for 30,000 hours spent reviewing and coding some 1 million documents to be produced by its client; notwithstanding the time, money and effort spent, a number of documents highly damaging to the client's case slipped through the net and were produced to opposing parties.

Transport. In addition to the numerous copies needed to prepare the various files, there is the problem of transporting these documents from place to place. For example, when a witness is to be deposed, counsel takes the witness file to the deposition site. If the deposition is held locally, there is no particular problem. More often, however, the deposition is held in another city or even overseas, thus requiring the transport of sometimes dozens of boxes of documents. During these distant depositions, it is inevitable that, despite careful advance preparations, a key document is discovered to have been inadvertently left behind or overlooked. Personnel back at counsel's office are then sent scurrying about to locate the missing document with uncertain likelihood of success.

In conclusion, therefore, there exists a need for improving the main activities of discovery, particularly document production, by using an improved system and method to manage the information. Those skilled in the art recognize that this need has been shown in the legal field, and that similar needs exist to manage documents in virtually any field having a plurality of documents or other such information.

### SUMMARY OF THE INVENTION

The present invention offers a system and method that addresses the inefficiencies encountered with current document-management methods. As shown herein, the present invention will be described in relation to managing documents and other information related to litigation. Those skilled in the art will recognize that the inventive concepts disclosed herein are equally applicable to most fields having a plurality of documents.

In a preferred embodiment, the system may: reduce the need to create and maintain numerous photocopies of every document produced by parties to litigation—some 99% of which are irrelevant—while permitting copies to be printed to local printers as needed; allow most or all documents in a lawsuit to be converted into searchable digital files and stored on the company's secure servers, thus permitting clients to make much better use of valuable and expensive office space, equipment, and personnel resources; reduce the need to spend time and money coding hundreds of thousands of documents in order to find the fewer than about 1% that are relevant to the issues in the case; and allow most or all information to be accessed and retrieved instantly over the Internet or similar wide area network from any location and at any time, thus allowing selected documents or other information to be downloaded to a user's personal computer for offline review and easy transport anywhere in the world.

The present invention provides a robust and fully searchable database that allows counsel to locate and use quickly, and with greater certainty, the information that is more relevant to his or her case. Users may then index and place that information into any number of personal files or case files, complete with notes and comments, such that they can be shared among colleagues and/or co-counsel. Though this document-management system and method is applicable to any discipline having a plurality of documents, a preferred use of the invention is by litigation attorneys.

The present invention improves on the tremendous inefficiencies inherent in current document- and information-management methods. The system may include a comprehensive set of services that may significantly change the way that the preliminary aspects of litigation are handled. The present system and its method of use offer an online data storage-and-retrieval system that may be scalable, efficient, searchable, transportable, easily managed, intuitive, and/or economical. The user can reduce much of the paper that currently clogs the system and access the entire database of documents and other information over the Internet or similar wide area network from anywhere in the world.

Although described in the context of litigation with representative users that may be attorneys and paralegals, the invention is also particularly well suited to a number of other applications. Corporate and securities sections of law firms or companies, for example, may find the archival and retrieval services particularly useful in their document-intensive activities such as due diligence, mergers-and-acquisitions data rooms, preparation of Securities & Exchange Commission filings, and maintenance of forms files. Similarly, accounting firms may use the invention for document-intensive activities, such as preparation and maintenance of audit-letter files and the storage and archiving of thousands of tax returns. In short, any field managing a plurality of documents may benefit from the present invention. The description and implementation of this system and method of managing documents within the legal context represents but one embodiment, and nothing herein is meant to limit the invention to this embodiment.

The present invention offers document-management services broadly grouped into the categories of storage and retrieval. These services, all of which are Internet-based, are delivered to the company's clients over the Internet or similar wide area network. Unlike traditional providers of such services, which rely on techniques that have changed very little over the past ten to fifteen years, the company has developed an innovative system that shifts the current paper-based method to a digital system accessible via a wide area network that is highly efficient, searchable, scalable, transportable, easily managed, intuitive, and/or economical.

The present invention reduces the need to maintain hard copies of documents (including the separate pristine and working sets) by allowing images of all original documents as well as digitized versions of electronic documents to be stored on a secure server accessible over the Internet or similar wide area network, only to authorized users, at any time and from any place. When a hard copy of a given document is needed, it can be printed to a local printer with the click of a mouse or similar method of activation. The user of the system has the option to either print one document at a time or print a range or batch of documents. Furthermore, the user can elect to print documents with or without the unique document number listed on the printout. The system's clients no longer need to make multiple copies of documents, typically more than 99% of which may be irrelevant to the issues of the case.

By storing data on secure servers and allowing full access to them over the Internet or similar wide area network, the present invention allows clients to free significant amounts of valuable office space, not to mention personnel and equipment resources, for more productive uses. Moreover, unlike working with hard copies (where one needed document may be in a box buried at the bottom of a mountain of boxes in one location, and another document may be in another buried box in a second location), the present invention makes all data readily searchable and immediately available in one location—the user's computer.

The present invention also allows trial counsel to access the entire universe of documents without having to go through the time and expense of coding. By immediately converting all documents produced by the various parties into fully searchable data files, the system reduces errors, misinterpretations, and transposition problems common in the current coding process. When selected documents need to be indexed, the clients may simply “copy and paste” information directly from the online document to the document index, thereby eliminating the possibility of transposition errors and allowing personnel to work much more efficiently.

By allowing the clients to download entire witness files into a laptop computer or similar portable device, tens of thousands of pages of documents can be transported anywhere without lugging heavy and cumbersome boxes across the country or around the world. If, during a deposition or at trial, a user determines that a key document is missing or has been overlooked, he or she can immediately locate it online and print it to a local printer to be entered into evidence.

The present invention offers significant improvements to these areas, including overcoming the inefficiencies and high costs of the prior art. Whether the present invention is used by one party or as document repository for all parties, the company places the entire universe of documents for a case into its central database from where these documents can be accessed over the Internet or similar wide area network at any time and from any place. As the case progresses, all documents that are produced or generated during the pendency of the case (e.g., new documentary evidence, pleadings and orders, correspondence and memoranda, and similar materials) can be added. There are several obvious advantages, including:

1. the entire universe of documents may be stored on the company's database and may remain available to clients during the pendency of the case (in the traditional system, documents overlooked during the first review are, for all intents and purposes, lost to the case);

2. through the innovative use of file sharing, unlimited virtual “copies” of documents may be made and stored in individual files set up by each attorney according to subject matter, issue, or witness;

3. documents or portions of the database may be downloaded into personal computers for easy transport or offline review;

4. because all documents are located on the company's database, the major problem faced by law firms—handling and storing thousands of boxes of photocopies—may be reduced or eliminated;

5. as hard copies of documents are needed, they may be printed to local printers with the click of a button or similar activation method;

6. increased security via various authentication methods protects access to case-sensitive information. Furthermore, all activity can be tracked, measured, and reported. If security breaches are discovered, there is a higher likelihood the culprit can be found and brought to justice. If the system has been violated, the offender's access can be instantly denied;

7. additions, improvements, and advancements to the technology can be deployed to clients instantly without the need for additional cost, time, installations, configurations, and various other resources; and/or

8. new and improved collaboration and communication tools not available in the prior art.

Moreover, the present invention may reduce or eliminate the need for document coding, thus dramatically streamlining the process of document review. Firms will not be obliged to employ small armies of employees to spend many months and enormous sums of money coding all documents that have been produced in an effort to find the few documents that are relevant to the case. Moreover, the company's system may help counsel find the proverbial “needle in a haystack” by conducting searches (including full Boolean searches) of all documents in the database, and then allowing them to focus solely on those documents that are of likely relevance to the case. This feature also greatly enhances the likelihood that counsel will find more relevant documents. Traditional coding, as noted in the Background of the Invention, often overlooks documents or misinterprets their significance. In the prior art, traditional coding simply creates a searchable database of user-determined summary information for each document. The present invention makes every word of every document searchable by way of highly automated processes.

Another feature of the present invention is the method of assigning document identification numbers or similar unique identifiers. Every page of every document produced in a case should have a unique identification number—a task that is currently done manually. By contrast, each page processed by this system is automatically assigned a unique number (parameters for the number are set by the clients) such that the unique number and the document are electronically and inextricably tethered to one another. The importance of this feature should not be underestimated. With traditional coding, Bates numbers are often transposed or erroneously coded, rendering the document difficult to locate. The present system obviates this problem. For example, if a search of the database of documents provides a given number of “hits,” the unique number for each document returned in the list may tether or link to the image of the document itself and dramatically reduce or eliminate lost documents.

Another feature and advantage of the system is that, after a document has been found to be relevant, it can easily be made part of a document index. The index may be constantly updated and can be viewed online or printed to local printers. The document index and the documents referenced therein may be fully searchable. An index entry and its corresponding document may be tethered or linked together such that when a search is conducted, the user can immediately see an image of the actual document rather than attempting to locate it among hundreds of boxes of documents. Later users, as theories of the case develop, may review an already indexed document and supplement or amend the information previously entered and, in a dedicated section, make notes, comments and annotations for any number of purposes. These notes, comments and annotations can be designated as private or public to all authorized users of the case at the author's discretion. Furthermore, the system may reduce the risks of lost or misplaced documents and may allow clients to create unlimited files and/or folders for individual users—particularly useful in situations such as when counsel is preparing for a deposition or trial.

The present invention offers a less expensive method of managing documents. For purposes of comparison, assume the 1.2 million pages in the document universe for the case noted in our above-referenced example and assume further that it lasts three years. Each party will currently pay approximately $1.8 million (i.e. $1.50 per page). Even if there is some cost sharing (e.g., coding costs shared by all defense counsel), the total per-firm cost is still staggering. By comparison, the present invention allows for the charging of a flat per-page rate to scan all documents, convert them to searchable data files, make them accessible over the Internet or similar wide area network, and provide full indexing capabilities. Each client may also pay a modest monthly storage and/or transmission fee based on the number of documents stored on the system.

### BRIEF DESCRIPTION OF THE DRAWINGS

FIG. 1 is a flow diagram of Document Scanning, Imaging, and Enhancements of a preferred embodiment;

FIG. 2 is a flow diagram of Image Compression, Text Recognition, and Verification of a preferred embodiment;

FIG. 3 is a flow diagram of Image Compression and Text Recognition of one embodiment;

FIG. 4 is a flow diagram of Text Verification and Correction of a preferred embodiment;

FIG. 5 is a flow diagram of Image Compression, Text Recognition, and Verification of one embodiment;

FIG. 6 is a flow diagram of Image Compression, Text Recognition, and Verification of another embodiment;

FIG. 7 is a flow diagram of Database Conversion of a preferred embodiment;

FIG. 8 is a flow diagram of System Configuration for Managing Documents of a preferred embodiment;

FIG. 9 is a flow diagram of Annotations of a preferred embodiment;

FIG. 10 is a flow diagram of Redactions of a preferred embodiment; and

FIG. 11 is a flow diagram of Offline Viewer/Database Contributions of a preferred embodiment.

### DETAILED DESCRIPTION OF PREFERRED EMBODIMENT

Though the following description offers the preferred embodiment of using the present invention in the context of legal procedures such as litigation, those skilled in the art will recognize that these systems and methods are equally applicable to any discipline having a need to manage a plurality of documents. Numerous variations and modifications may be effected in other disciplines having a plurality of documents without departing from the true spirit and scope of the novel concepts of this invention.

A few terms used herein are defined as follows. The word “page” is used generally to refer to a single sheet of paper of any size, shape or character (e.g., letter, photograph, blueprint, newspaper or magazine, etc.) comprised of both a face side and a reverse side. A page may also be in digital form (e.g., a computer file) or may be a pre-existing image. A “document” includes one or more pages comprising a discrete unit (e.g., a letter and its attachments, a contract and its appendices) or one or more pages that may have been assembled (e.g., by means of a paper clip, staple, binder or otherwise) into a discrete unit by the owner thereof. A document may be in either paper form or electronic form (e.g., email; web page). A “folder” comprises one or more documents that have been assembled into a discrete unit by the owner thereof. One folder will typically be separated from other folders by means of, for example, a binder. A binder may contain labeling or other descriptive information identifying the contents thereof and/or distinguishing it from other binders (e.g., one binder might be labeled “1996 Payroll Records A-L” while another might be labeled “1996 Payroll Records M-Z”). The word “batch” includes one or more documents and/or files forming a unit for purposes of processing by the company. There is no fixed or predetermined size of a batch, and a batch may consist of, for example, five one-page documents, two 500-page documents or hundreds of files, each containing a single one-page document. An “owner” denotes the person or entity (including departments or subdivisions thereof) to whom documents belong or from whom the documents were obtained.

The following embodiment of a system and method represents but one method to implement the present invention. The teachings herein may be adapted to a variety of arrangements and configurations while still embodying the scope of the invention.

FIG. 1 is a flow diagram of Document Scanning, Imaging, and Enhancements of a preferred embodiment.

Document Preparation.

In a preferred preliminary step, the documents received from the owner thereof are prepared for the first step of processing, the scanning operation, where “photocopy images” of each page are made. A “photocopy image” or “image” is a digital rendering of a paper page or document and my or may not be “compressed”. “Compressed” or “Compression” describes the process of reducing the file size of images while maintaining the visual integrity of the image. At this stage personnel may first determine “logical batches”. A “logical batch” may consist, for example, of all documents that have been produced by a single owner (e.g., “John Smith”; “XYZ, Inc.”) or documents originating from a given location (e.g., “John Smith's Filing Cabinet”; “XYZ, Inc. Chicago Facility”) or person (e.g., “Sally Jones XYZ, Inc.”). A logical batch, depending upon its size, may be separated into one or more processing batches. Logical batches and/or processing batches may be separated from one another by specially coded sheets, recognizable by the system, that indicate the beginning and/or end of each such batch. These coded sheets may also include special, automated imaging instructions, recognizable by the scanner. Next, foreign objects such as staples and paper clips are removed from each document and specially coded sheets, likewise recognizable by the system, are inserted to separate one document from the next. Specific information for each logical batch (e.g., client name; case information; owner identity; batch sequence number) may be provided to construct a “system number” (i.e. file prefix) for each document; the system number may later serve as part of the unique number sometimes referred to as the InterLegis and/or Bates number. Finally, the prepared documents are delivered to one or more scanning stations for the imaging operation.

Document Imaging.

Documents are typically scanned using high-speed scanners to capture photocopy images thereof. The system number and “sequence seed” for each batch are entered into the system by personnel operating the scanner. The scanner operator may manually set the parameters for the batch to be scanned, which parameters may vary from one document and/or batch to another. For example, some documents with very small fonts (e.g., purchase orders) may require a higher resolution (e.g., 300 dpi or higher) than would standard letters or correspondence (e.g., 200 dpi).

In a preferred embodiment, documents being scanned can be automatically separated from one another by specially coded sheets. In the alternative, the operator manually instructs the system, by means of buttons, pedals or other manually activated devices on the scanner, to separate documents from one another. One method, for example, might have the operator pushing a certain button (“button 1”) to instruct the system that, until otherwise instructed, each page scanned thereafter is to be treated as a single-page document, while the operator pushing another button (“button 2”) might instruct the system that, until otherwise instructed, each page scanned is to be treated as part of a multi-page document. When a multi-page document has been completely scanned, the operator would then push either button 1 (where there follow more single-page documents) or button 2 (where there follows another multi-page document). In some circumstances, manual document separation may be quicker and more efficient than the use of separator sheets previously described.

As each page is scanned, the operator preferably receives a miniature view thereof on a computer monitor connected to the scanner, thereby allowing the operator to determine at a glance, at this earliest stage of document processing, that a page has been properly scanned. This helps to eliminate the time-consuming task, at some later stage of the process, of locating the specific page of a document from among the possible thousands of documents that needs to be re-scanned.

Documents may be scanned, by default, in duplex mode, which provides two images of every page (i.e. its face side and its reverse side). The system determines whether either side of a page is blank and then either: automatically deletes it from the queue; or gives the operator the option of deleting it manually from the queue. In a preferred embodiment, the parameters for determining whether a page is “blank” can be changed by the operator, depending on the type of documents in a batch. Thus, for example, the system can be set to consider as “blank” any page with less than about 4 kilobytes of information (e.g., the amount of data that might be contained on an otherwise blank 3-hole punched page with some limited “noise”). In an alternative embodiment, the operator may manually verify, prior to scanning, that the reverse side of every page in a batch is blank and thereby instruct the system to operate in simplex mode. Because the system will be processing half the number of images as it would in duplex mode, this procedure in this variation can provide significant timesavings and allow faster document processing.

Ultimately, the system creates an exact photocopy image of each page of each document (minus any deleted blank sides) and then passes the document images downstream for further processing. In a preferred embodiment, the document images passed downstream will have been formatted as Tagged Image File Format (“TIFF”) images; nevertheless, it should be recognized that any other format, whether or not compressed, would be covered by this invention.

After determining that all documents in a batch have been properly scanned, the scanner operator may return the documents to the preparation area where personnel reassemble the documents and files to their original condition and arrange to have them returned to their owner.

Alternative to Document Scanning.

In some instances, documents may be in an electronic format or may already have been imaged prior to being sent to the company. Therefore, as one alternative to the foregoing manual scanning process, electronic documents or documents previously imaged may be provided to the company for downstream processing. The document images may be provided on any traditional media (e.g., DVD, CD-ROM, floppy discs) or electronically (email, file transfer). In a preferred embodiment, document images existing in a format other than TIFF (e.g., JPEG, BMP, PDF) would be converted by the company during an optional additional step into TIFF files for downstream processing; however, the conversion to TIFF, while preferred, is not an essential component to the overall processing.

Image Enhancement.

Before proceeding to the next stage, documents may undergo a further additional step to correct any number of problems that may make text recognition more difficult or inaccurate. While this step is contemplated to be entirely automated, it can also be rendered a manual process. Examples of corrections that can be made may include, without limitation: rotating images so that they are presented in the manner in which they would be read by humans; de-skewing images; removing excessive “noise”; and de-speckling to remove stray dots that sometimes appear on photocopies.

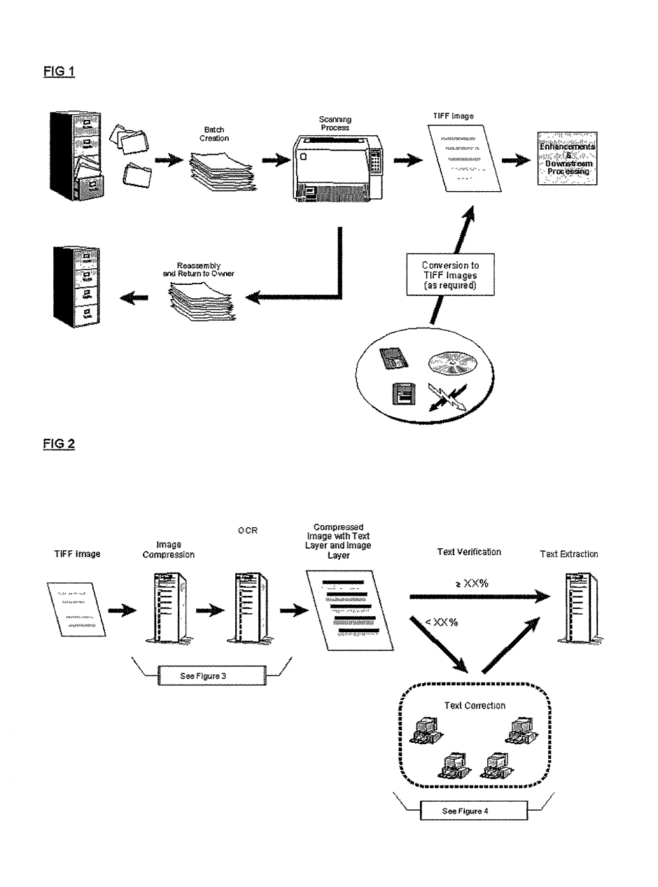

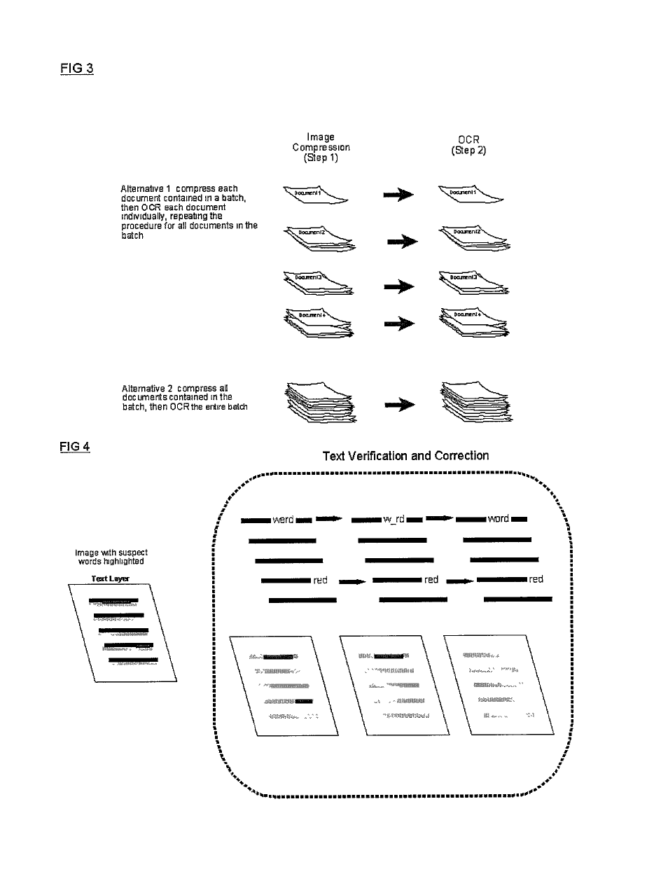

FIG. 2 is a flow diagram of Image Compression, Text Recognition, and Verification of a preferred embodiment.

Image Compression.

As shown in FIG. 2, the next phase has the document images, obtained by whatever means, passed downstream to at least one server that compresses them into a portable and more efficient format. The system may use image-compression formats including image-compression formats that incorporate a hidden-text feature.

Text Recognition.

Following compression, the images are sent to an OCR (Optical Character Recognition) processor in order to recognize any text contained therein. Furthermore, the OCR processor maps the text position in relation to the image in order to allow operators and end-users to easily find and view searched or flagged text on the image. While FIG. 2 shows two CPUs performing these functions (one for image compression and the other for OCR), both functions may just as easily be performed by a single CPU or, where appropriate, multiple CPUs (e.g., one CPU for image compression and two for OCR; two for image compression and five for OCR; and so forth). This portion of the process may be fully automated, with limited or virtually no human intervention beyond ensuring that batches of documents properly arrive and leave the processor(s). At the end of this phase of the process, a compressed digital image containing both an image layer and a text layer has been created.

As shown in FIG. 3, a flow diagram of Image Compression and Text Recognition of one embodiment, there are at least two possible alternative procedures in the image-compression/text-recognition phase. In one, each document of a batch is individually compressed and then sent on for OCR processing; the procedure is repeated for every document in the batch (NB: as indicated in the illustration, it should be recalled that a document may consist of either a single page or multiple pages). In another alternative, all documents of a batch are compressed as a group and then sent on for OCR processing. In another alternative, all documents of a batch undergo the OCR process, and then converted to a compressed image format.

During OCR processing, the system generates internally for each document a “score” indicating the degree of confidence or certainty that the text contained therein has been recognized accurately. The processes of assigning a score to the OCR accuracy are called “Verification.” The closer the score is to b 100, the more confident is the system that it has accurately recognized the text. In most typical circumstances, all documents that go through the OCR process proceed automatically to the “Correction” step. However, as a more efficient alternative, the system can be set up so that a predetermined, adjustable score on a given document would allow that document to bypass verification altogether, allowing the document to proceed instead directly to text extraction; any document whose score falls below that predetermined number would go into the correction queue. In other words, if the company determines that, for a given batch, only documents with a score lower than, say, 98 will undergo manual correction, all documents with that score or higher would proceed directly to text extraction, while all documents with a score falling below that score would proceed to the next, intermediate processing step.

Text Correction.

As each batch completes the OCR stage, all or portions of it may be passed downstream for text verification. Text “correction” is, by necessity and design, a manual process that allows personnel to review processed documents to confirm accuracy and to correct any errors that may have occurred during automated text recognition; because it is a manual process, it has been represented in FIG. 2 as requiring multiple workstations.

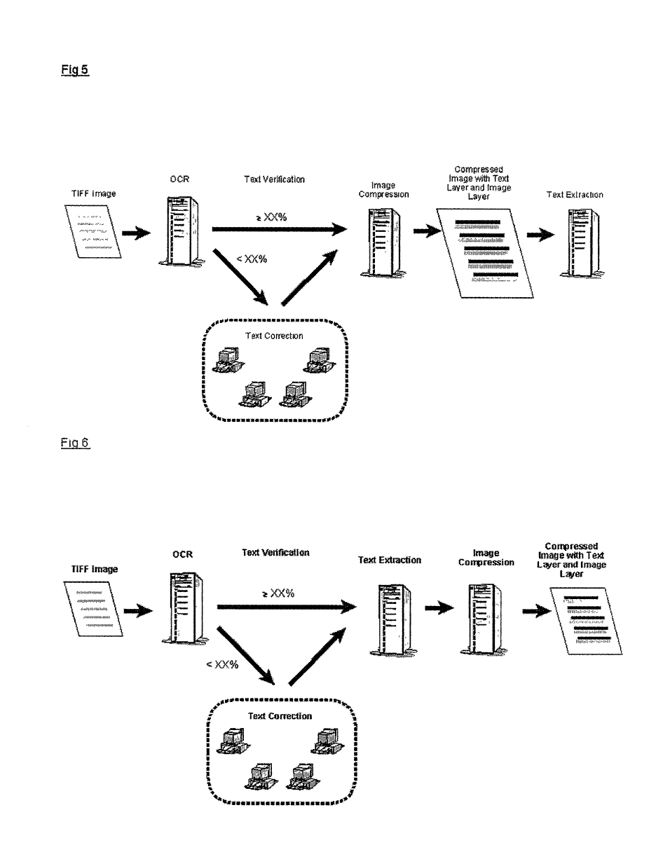

As illustrated in FIG. 4, a flow diagram of Text Verification and Correction of a preferred embodiment, the document leaving the OCR stage is thought by the system to contain two suspect words (i.e. “werd” and “red”). Suspect words are highlighted in some fashion (e.g., bold typeface, different colored text, a box around it) in both the text layer and the image layer so that they are readily apparent to personnel at the text-correction workstations. The operator may be presented, by means of a split-screen display, with both the text layer containing the highlighted suspect word(s) and the image layer showing the document in question, likewise with the suspect word(s) highlighted; typically, depending upon the size and resolution of the monitor used with a verification terminal, only the portion of the text layer containing the suspect word and the corresponding portion of the image layer are displayed. By referring to the image of the document, the operator can immediately determine that the word “werd” is incorrect and manually correct it in the text layer and that the word “red” is correct and thus confirm it as is. When all suspect words of a document have been either confirmed or corrected, the operator then accepts the document; the corrected text layer and the image layer are merged to create a single image file with searchable text. The merged file is then passed downstream for further processing.

FIG. 5 shows is a flow diagram of Image Compression, Text Recognition, and Verification of one embodiment. Although the company has set forth above and in FIG. 2 one possible solution, it is recognized that there may be other variations in the actual order of the processing steps. FIG. 5, which illustrates one alternate possible method of accomplishing the same tasks, shows that the text-recognition and -verification processes occurring directly from the TIFF image, with image compression occurring thereafter.

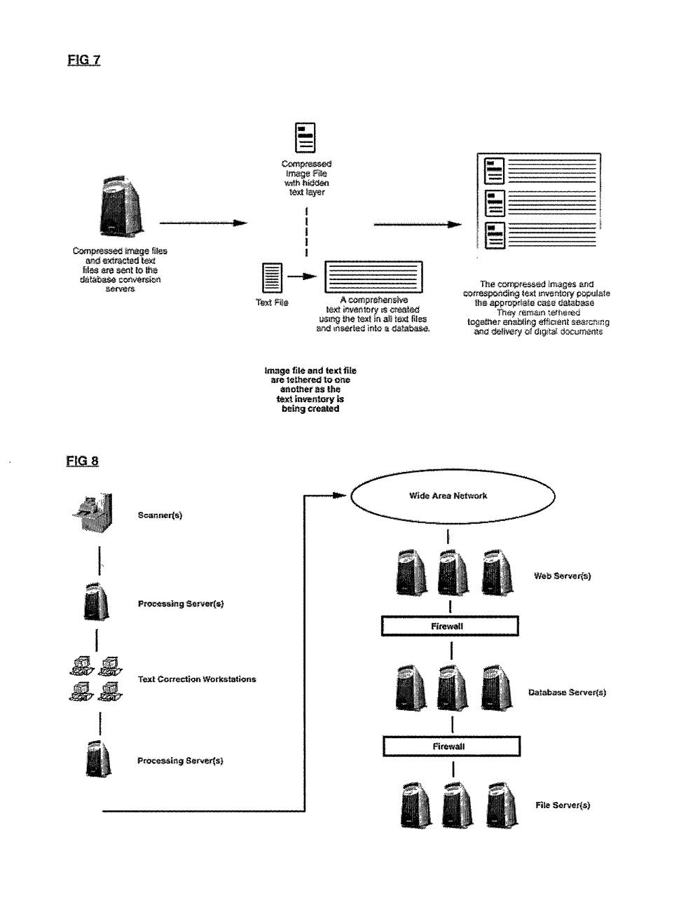

As depicted in FIG. 6, a flow diagram of Image Compression, Text Recognition, and Verification of another embodiment, the next stage of processing involves constructing a searchable database of all the documents in a matter. The particular advantage to the company's system is that it allows for word searches to be conducted in a dedicated text database, thereby providing much faster and much more efficient search functionality than would be possible by searching the text layer of each individual document, one at a time.

Text Extraction.

The text generated during the foregoing text-recognition phase (whether or not manually corrected) is extracted from the text layer of each compressed digital image to create a separate, yet tethered text file. Although the system preferably uses a TXT extension, any other text file (including, without limitation, Rich Text Format [“RTF”], American Standard Code for Information Interchange [“ASCII”], formatted ASCII, and American National Standards Institute [“ANSI”]) may also be used.

Database Insertion and Indexing.

As shown in FIG. 7, a flow diagram of database conversion, the text thus extracted is used to construct the searchable database. An entry containing specific information about each document (e.g., file name, file size, word count, and source and location) is added to the database (this may or may not take place in the order indicated here). Next, in order to optimize the search function, every word contained in the each text extract of each document is processed in order to make a “text inventory”. Creating “text inventory” is a process whereby information about each and every word in all text files is noted and saved in the database. This information includes, but is not limited to: every instance of each word, in which documents they reside, the location of each word in every document, and possible variations of each word for more “fuzzy” queries. Once the “text inventory” has taken place, all text files are discarded.

As the text file is being indexed, the compressed digital image, together with its hidden-text layer, and the database of inventoried text are tethered to one another by means of the unique number(s). The compressed digital image and its corresponding inventoried text populate the appropriate case database and remain tethered together enabling efficient searching and delivery of digital documents. This enables a user of the system to enter a particular search term(s) in order for the system to immediately identify all instances of the term(s) in the text database and view all corresponding images.

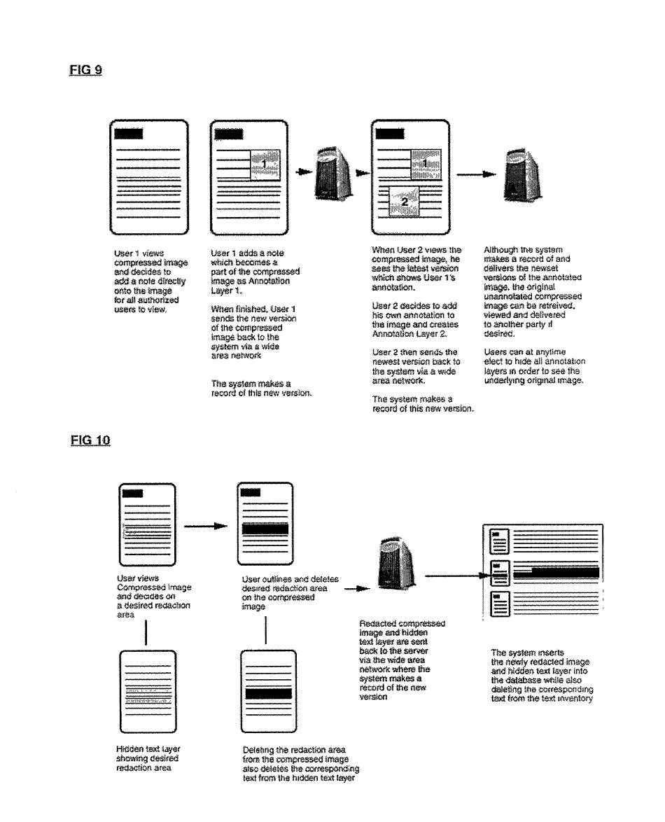

In a preferred embodiment, as shown in in FIG. 8, a flow diagram of System Configuration for Managing Documents of a preferred embodiment, the compressed digital image resides behind a firewall to the company's Internet servers. As part of the database population, a process on the system's Internet or similar wide area network server monitors the arrival of new files.

At the document organization stage, clients may log in to the system's Web site to review and organize case documents. Each user would be provided with individual user identification and passwords. In the preferred embodiment, each user may have different permissions or levels of access to case files, depending upon criteria established by clients. Each is given access to authorized case data by way of password authentication within a Secured Socket Layer (SSL) Encrypted session, or any similar encryption method.

Thus, for example, trial counsel would likely have full and unlimited access to all documents, files, notes, and comments in a case, whereas a case clerk or other low-level employee might be restricted to reviewing and indexing documents. Next, upon logging onto the system site, the user receives a list of cases to which he or she has been granted access. After selecting a case, the user may, subject to specific permissions, access and search any or all documents for that case.

At the client's discretion there are additional levels of security that can be incorporated into the system. These include, but are not limited to, IP address matching/filtering, personal digital certificates, dedicated network access, and/or dedicated database/file servers or firewalls. “IP address matching/filtering” refers to the process of allowing only a certain IP address range to access pre-determined cases and/or databases. “Personal digital certificates” refers to specialized instructions or software that resides on the user's computer. The system allows only users with certain matching or pre-authorized certificates to have access to cases and/or databases. “Dedicated network access” refers to either a wide area network connection that is only used to connect the user (or a group of users) directly into the system. This can be achieved by either a physical connection or a software-based solution residing on the user's computer. “Dedicated database/file servers or firewalls” refer to any combination of dedicated hardware that is installed on the user's premise whereby all or a portion of the access to the system does not require the use of a wide area network.

It is envisioned that: the user may access and search all documents for the case (i.e. the “document universe”) or just those documents that have previously been indexed (see discussion of indexing, below). In addition, a user may search by using simple keywords, exact phrases, or complex Boolean expressions (i.e. employing such terms as “and”, “or”, “within x”, “but not”, “near” and “like”). Furthermore, a user may narrow the range of potentially relevant documents by successively refining each set of search results.

Thus, for example, a search of the document universe for the term “employment contract” may result in one thousand “hits.” By searching those search results for the term “1997,” the user may narrow the number of documents to one hundred. The user may further narrow the number by searching just those documents for the term “January or February or March.” Furthermore, all searches are automatically saved and are immediately accessible to users via a click of a button, selection from a drop-down menu, or similar method of activation.

Preferably, results for each search are displayed to the user in a list of documents that provides several important pieces of general information about the document (e.g., document number, file size (in bytes), word count, and an indication whether the document has been indexed). Moreover, the searched-for term and several lines of text above and below may be displayed so that the user may readily determine whether the document warrants further review. Additionally, a hyperlink may be tethered to the document list such that the user may review the actual document in question. Finally, a hyperlink may be tethered to the image that allows the user to create an index entry for that document or, if there has already been an index entry created, to view or edit it.

As a user reviews a document and determines it to be potentially relevant, he or she may create an index entry for it. This index entry may include an online, customizable “index sheet” and the “look” and content may be changed from one case to another to meet specific client needs or requirements. This index sheet may comprise certain predefined fields (key names or concepts, for example) that are likely to recur often in the documents. This functionality allows for both greater speed (e.g., a frequently recurring name can be entered by a single keystroke rather than being retyped in full each time it arises) and greater accuracy (e.g., the possibility of misspellings or transposition errors is significantly reduced).

Additionally, the index entry may allow the user to enter relevant information from the document (e.g., author, subject, date), comments, notations, and so forth. The index entry may help avoid having “lost” documents because the system preferably will not allow an index entry to be created unless the user provides at least a certain minimum amount of information about the document (e.g., date, author, document type). In a preferred embodiment, the user is able to “copy and paste” text directly from the document image into the index sheet.

As each index entry is submitted to the system, the index entry and the document to which it relates become part of a specific and discrete database that is unique to that client and that case. This database is, in essence, a subset of the document universe and, as “work product,” is not accessible by anyone not specifically authorized by that client. The relevance of this functionality is apparent where the company serves as document repository for two or more parties to a case. Each party will conceivably index a completely different set of documents from the document universe for the case. Moreover, each will have its own database (i.e. work product) that the party may not want the other party to access.

In addition, a user may organize indexed documents into any number of “briefbags” containing a virtually unlimited number of folders and subfolders. These briefbags might contain, for example, all documents relating to a given issue in the case. Each folder contained therein might contain documents relating to specific sub-issues. Moreover, the organization system should be entirely customizable by the client, and any user may establish his or her briefbag (or series of briefbags).

Furthermore, a briefbag may be made “private” (e.g., trial counsel may want to keep certain elements of trial strategy confidential) or may be shared among certain or all members of the team. Similarly, notes and comments may be attached to a specific folder or document and may be marked as private or may be shared among certain or all members of the term. In furtherance of the concept of the search function discussed above, a user may elect to view only those documents contained in briefbags/folders by browsing the briefbags and clicking on the files they contain.

Users also have the ability to make notes and/or comments directly on the document image by utilizing the “Annotation” feature as shown in FIG. 9. While viewing a document image, the user can elect to select a region of the image and add his or her personal text to that region. This annotation does not become permanently embedded into the image; rather, it is a layer that resides on top of the image. Once finished with the annotation, the user can send the new version back to the system via the same secure connection where it gets entered into the database. The system automatically keeps track of each and every new version that is entered into the database. Other users who access the newer, annotated image have the option to hide or suppress the annotation(s). Furthermore, users can elect to print the document with or without the annotation. In a preferred embodiment, all annotations shall become part of the text inventory in the database, thus making it searchable by other users.

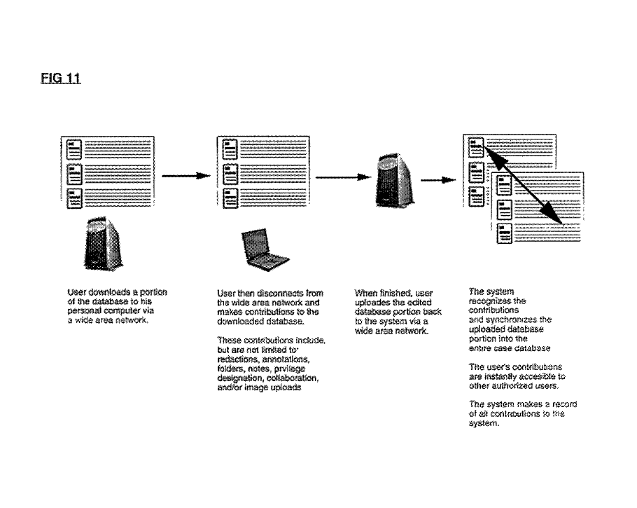

If portions of the document image need to be hidden for the purpose of document production to another party that represents the other side of the litigation proceedings (i.e. defense team to prosecution team), users with appropriate access can “Redact” the document image as shown in FIG. 10. The process of redaction involves selecting the desired section of the image to be blocked out or deleted. By doing so, the selected section is no longer visible on the image. As part of the redaction feature, the system removes the corresponding text from both the text layer and the searchable text inventory in the database. Once the image has been properly redacted, the user can send the new version back to the system via the same secure connection where it gets entered into the database. The system automatically keeps track of each and every new version that is entered into the database. At any given time authorized users can view the original document image without the redactions. In the event that the document images need to be produced to the other side of litigation proceedings (either electronically or as printouts), all redacted documents will supercede their respective originals.

If a user decides to designate a document as privileged, he or she can do so by simply changing the “Privileged flag” from “no” to “yes” via a click of a button, selection from a drop-down menu, or similar method of activation.

Users of the system also have various means in which to collaborate and communicate with one another as they prepare for cases. One method allows users to send search results, folders, files, and/or personal comments about the referenced search results, folders, and/or files to one or more authorized users of the case. The collaboration system allows users instantly view search results, folders, and/or files with a single click of a button or similar activation method.

Users also have the ability to directly upload images or other electronic files into the system for processing. This upload, via file transfer protocol (FTP) or other similar methods of transmission, will occur in a secure environment and will be automatically entered into the necessary processing steps for insertion into the searchable database.

In a preferred embodiment, the system may allow most or all information to be accessed and retrieved instantly over the Internet or similar wide area network from any location and at any time, thus allowing selected documents or other information to be downloaded to a user's personal computer for offline review and easy transport anywhere in the world such as the procedure shown in FIG. 11. In this embodiment, the user downloads a portion of the database to his personal computer via a wide area network. The user then disconnects from the wide area network and makes contributions to the downloaded database. These contributions can include, but are not limited to: redactions, annotations, folders, notes, privilege designation, collaboration, and/or image uploads. When finished, the user then uploads the edited database portion back to the system via a wide area network. The system recognizes the contributions and synchronizes the uploaded database portion into the entire case database. The user's contributions are instantly accessible to other authorized users. The system then makes a record of all contributions to the system.

Other features may be incorporated within the invention. For example, the present invention reduces the need to maintain hard copies of documents (including the separate pristine and working sets) by allowing images of all original documents as well as digitized versions of electronic documents to be stored on a secure server accessible over the Internet or similar wide area network, only to authorized users, at any time and from any place. When a hard copy of a given document is needed, it can be printed to a local printer with the click of a mouse or similar method of activation. The user of the system has the option to either print one document at a time or print a range or batch of documents. Furthermore, the user can elect to print documents with or without the unique document number listed on the printout. The system's clients no longer need to make multiple copies of documents, typically more than 99% of which may be irrelevant to the issues of the case.

Moreover, the present invention may reduce or eliminate the need for document coding, thus dramatically streamlining the process of document review. Firms will not be obliged to employ small armies of employees to spend many months and enormous sums of money coding all documents that have been produced in an effort to find the few documents that are relevant to the case. Moreover, the company's system may help counsel find the proverbial “needle in a haystack” by conducting searches (including full Boolean searches) of all documents in the database, and then allowing them to focus solely on those documents that are of likely relevance to the case. This feature also greatly enhances the likelihood that counsel will find more relevant documents. Traditional coding, as noted in the Background of the Invention, often overlooks documents or misinterprets their significance. In the prior art, traditional coding simply creates a searchable database of user-determined summary information for each document. The present invention makes every word of every document searchable by way of highly automated processes.

Though the preferred embodiment as depicted herein represents an embodiment of the invention should allow for the flexibility and versatility for embodiments not described or depicted herein. Those skilled in the art will realize its significant variation and deviations from this embodiment are meant to be within the scope of this invention.

We claim:

1. A process for managing documents which comprises the steps of:
recognizing text in each image;
extracting the text to form a text file;
verifying the text file which comprises the sub steps of generating an adjustable score threshold and scoring each text file to determine if the text file exceeds the score threshold; and
using the text file to form an inventory of every word;
wherein the process occurs without manual coding.

2. The process of claim 1 which, prior to the step of recognizing text in each image, further comprises the steps of:
scanning each document to form each image; and
assigning a unique number to each image.

3. The process of claim 1 which, after the step of using the text file to form an inventory of every word, further comprises the step of forming a database wherein the database comprises:
each image;
each text file;
and the text inventory.

4. The process of claim 1 which further comprises the step of correcting text files that fail to exceed the adjustable score threshold.

5. The process of claim 1 which further comprises the step of mapping text position in relation to the image.

6. The process of claim 1 wherein the text file is a separate file tethered to the image.

7. The process of claim 2 which further comprises the step of inserting sheets containing specific automated scanner instructions between at least two documents prior to the step of scanning each document to form each image.

8. The process of claim 2 which further comprises the step of changing the resolution of at least one image.

9. The process of claim 3 which further comprises the step of allowing users to access the database via a wide area network.

10. The process of claim 9 which further comprises the step of establishing access levels.

11. The process of claim 9 which further comprises the step of allowing users to search the database, save search results of the database, view images from the database, request prints of images, or contribute to the database over a wide area network.

12. The process of claim 11 wherein a contribution to the database is an annotation, a redaction, a folder creation, a creation of record, a designation of privilege, an online collaboration, or an image upload.

13. A system for managing documents comprising:
extraction software capable of extracting text from images to form text files;
verification software capable of scoring each text file to determine if the text file exceeds an adjustable score threshold;
text indexing software capable indexing each text file to form an inventory; and
a file server capable of containing each image and the text inventory.

14. The system of claim 13 further comprising:
a database server capable of accessing the file server;
a web server capable of accessing a wide area network;
a first firewall that is located between the web server and the database server; and
a second firewall that is located between the database server and the file server.

15. The system of claim 13 further comprising a scanner capable of scanning the documents to form the images.

16. The system of claim 14 further comprising at least one user interface capable of connecting to the wide area network and accessing the web server in a customizable secure environment.

17. A method of using a system for managing documents, wherein the system comprises at least one server containing a database having images and a text inventory created from extracted and verified text layer exceeding an adjustable scored threshold from each image accessible via a wide area network, the method which comprises the steps of:
accessing via the wide area network; and
searching the inventory via the wide area network.

18. The method of claim 17 which further comprises annotating, redacting, printing, printing a batch of images, saving information to the database, managing different versions of an image or text entries, customizing record information, or collaborating with additional users over the wide area network.

19. The method of claim 18 wherein redacting alters both an image and corresponding portions of the text layer and the text inventory associated with the image.

20. The method of claim 17 which further comprises the steps of:
downloading a portion of the database on a user computer while connected to the system via the wide area network;
accessing and modifying the portion while not connected;
synchronizing the modifications to the database once reconnected to the system via the wide area network.
